(19) United States
(12) Patent Application Publication
(10) Pub. No.: US 2006/0292511 A1
(43) Pub. Date: Dec. 28, 2006

(54) Method of preheating head chips of printing device

(76) Inventor: Masahiko Habuka, Suwon-si (KR)

Correspondence Address: STANZIONE & KIM, LLP, 919 18TH STREET, N.W., SUITE 440, WASHINGTON, DC, 20006, US

(21) Appl. No.: 11/357,202

(22) Filed: Feb. 21, 2006

(30) Foreign Application Priority Data
Jun. 25, 2005 (KR) 2005-55420

(51) Int. Cl. F27B 9/12

(52) U.S. Cl. 432/18; 347/61

(57) ABSTRACT

A method of preheating head chips in which a drive signal that drives main heaters of the respective head chips is set so that ink is not ejected, and a frequency of the drive signal is set to be inversely proportional to a temperature rising rate of the respective head chips. Auxiliary heaters and the main heaters of the respective head chips are driven simultaneously to heat the respective head chips so that the head chips may reach a target temperature.

### CROSS-REFERENCE TO RELATED APPLICATIONS

This application claims the benefit under 35 U.S.C. § 119 of Korean Patent Application No. 2005-55420, filed on Jun. 25, 2005, in the Korean Intellectual Property Office, the disclosure of which is incorporated herein in its entirety by reference.

### BACKGROUND OF THE INVENTION

1. Field of the Invention

The present general inventive concept relates to a method of preheating a head chip of a printing device that performs printing by ejecting ink droplets.

2. Description of the Related Art

An inkjet printer includes one or more head chips, each head chip having nozzles and main heaters to heat ink to be ejected through the nozzles. The performance of the inkjet printer is associated with viscosity of ink. A shuttle inkjet head has one or more head chips, which are 0.5 inch long, and a line inkjet head has a plurality of head chips whose lengths are longer (about 2-inch long) than those of the head chips used in the shuttle inkjet head.

The viscosity of the ink is high in a low temperature and low in a high temperature. Therefore, the head chips should be uniformly maintained at a temperature at which the viscosity of the ink is appropriate for achieving an optimum printing condition. For that purpose, a printing device has auxiliary heaters heating the head chips and temperature sensors to measure temperatures of the head chips. The printing device detects the temperatures of the head chips right after power is applied (i.e., after the printing device is turned on) or during printing and controls the temperatures of the head chips by operating the auxiliary heaters to preheat the head chips if the detected temperatures are lower than a predetermined target temperature.

When the head chips are heated, the viscosity of the ink is lowered and drying of the ink is facilitated. When the head chips are preheated, times elapsed until reaching the predetermined target temperature are different for different head chips due to differences in temperature rising rates. Also, after a printing operation is completed, temperature differences may occur between the head chips, thus, the times elapsed until the respective head chips reach the predetermined target temperature may also be different. Accordingly, a drying of the ink process occurs in one head chip that has reached the target temperature first while the other head chip does not reach the predetermined target temperature.

### SUMMARY OF THE INVENTION

The present general inventive concept provides a method of preheating head chips capable of reducing a time difference between different head chips generated when the head chips are heated to a target temperature.

The present general inventive concept also provides a method of preheating head chips that allows the head chips to reach the target temperature more swiftly.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a method of preheating a one or more head chips of a printing device, each head chip including nozzles and main heaters to heat ink to be ejected through the nozzles, one or more auxiliary heaters to heat the head chips, and one or more temperature sensors to measure temperatures of the head chips, the method including setting a drive signal that drives the main heaters of the respective head chips so that ink is not ejected, and setting a frequency of the drive signal to be inversely proportional to a temperature rising rate of the respective head chip according to measured temperatures, and driving the auxiliary heaters and the main heaters to heat the head chips to simultaneously reach a target temperature from the respective temperatures.

The foregoing and/or other aspects of the present general inventive concept may also be achieved by providing a method of preheating one or more head chips of a printing device, each head chip including nozzles and one or more main heaters to heat ink to be ejected through the nozzles, one or more auxiliary heaters to heat the respective head chips, and one or more temperature sensors to measure temperatures of the head chips, the method including measuring initial temperatures of the head chips, calculating estimated heating times of the head chips until the head chips reach a target temperature based on temperature rising rates of the respective head chips, and starting heating the head chips by driving the auxiliary heaters from one of the head chips having a maximum value of the estimated heating times to the other one chips having a minimum value of the estimated heating times so that the head chips reach the target temperature when the maximum estimated heating time elapses.

The method may further include setting a drive signal that drives the main heaters of the head chips so that ink is not ejected and simultaneously driving the main heaters and the auxiliary heaters to heat the head chips. The temperature rising rate may correspond to when the main heaters are driven together with the auxiliary heaters with a predetermined duty and frequency for a predetermined period of time.

The method may further include measuring a temperature of the head chips in which a heating operation has not been started to recalculate an estimated heating time and adjusting a heating start time according to the recalculated heating time.

The foregoing and/or other aspects of the present general inventive concept may also be achieved by providing a method of preheating head chips in a printing device, each head chip including nozzles and main heaters to heat ink to be ejected through the nozzles, a plurality of auxiliary heaters to heat the head chips, and a plurality of temperature sensors to measure temperatures of the head chips, the method including measuring initial temperatures of the head chips and classifying the head chips into a high temperature group having the corresponding initial temperatures higher than a target temperature and a low temperature group having the corresponding initial temperatures lower than the target temperature, calculating estimated cooling times until the head chips of the high temperature group reach the target temperature based on temperature falling rates of the head chips of the high temperature group and calculating estimated heating times until the head chips of the low temperate group reach the target temperature based on temperature rising rates of the head chips of the low temperature group, and controlling auxiliary heaters to operate so that all of the head chips to reach the target temperature when a maximum value of the estimated cooling times and the estimated heating times elapses.

The controlling of the auxiliary heaters may include heating by driving the auxiliary heaters sequentially starting with auxiliary heaters from the head chip having the maximum estimated heating time among the head chips of the low temperature group so that all of the head chips of the low temperature group may reach the target temperature when one of the head chips among the high temperature group having a maximum estimated cooling time reaches the target temperature the maximum estimated cooling time being greater than the maximum estimated heating time, and intermittently driving the auxiliary heaters to maintain the head chips of the high temperature group that have already reached the target temperature at the target temperature until the maximum estimated cooling time elapses.

The controlling of the auxiliary heaters may include starting heating by driving the auxiliary heaters sequentially from one of the head chips having a maximum value of the estimated heating times to the other one of the head chips having a minimum value of the estimated heating time among the head chips of the low temperature group so that all of the head chips of the low temperature group may reach the target temperature when the maximum estimated heating time elapses when the maximum estimated cooling time is greater than the maximum estimated heating time, if all of the head chips of the low temperature group reach the target temperature, intermittently driving the auxiliary heaters to maintain the head chips of the high temperature group at the target temperature until the maximum estimated cooling time elapses, and intermittently driving the auxiliary heaters to maintain the head chips of the high temperature group that have already reached the target temperature at the target temperature until the maximum estimated cooling time elapses.

The foregoing and/or other aspects of the present general inventive concept are also achieved by providing a method of preheating head chips of a printing device, the method including calculating a first time of a first head chip using a corresponding first rate and a second time of a second head chip using a corresponding second rate, and controlling heaters of the first and second head chips according to the calculated first and second times, so that the first and second head chips reach a target temperature simultaneously.

The foregoing and/or other aspects of the present general inventive concept may also be achieved by providing an apparatus to preheat one or more head chips of a printing device, each head chip including nozzles, main heaters to heat ink to be ejected through the nozzles, one or more auxiliary heaters to heat the respective head chips, and one or more temperature sensors to measure a temperature of the respective head chip, the apparatus comprising a main heaters drive circuit to generate a drive signal that drives the main heaters of the respective head chips such that the ink is not ejected, the drive signal having a frequency inversely proportional to a temperature rising rate of the respective head chips, and an auxiliary heaters drive circuit to drive the auxiliary heaters and the main heaters of the head chips to heat the head chips to simultaneously reach a target temperature.

The foregoing and/or other aspects of the present general inventive concept may also be achieved by providing an apparatus to preheat one or more head chips of a printing device, each head chip including nozzles, one or more main heaters to heat ink to be ejected through the nozzles, one or more auxiliary heaters to heat the respective head chips, and one or more temperature sensors to measure temperatures of the respective head chips, the apparatus comprising a controller to receive initial temperatures of the head chips measured by the temperature sensors, to calculate estimated heating times of the head chips until the head chips reach a target temperature based on temperature rising rates of the respective head chips, and to control heating the head chips by driving the auxiliary heaters corresponding to the head chips sequentially from one of the head chips having a maximum value of the estimated heating times to the other one of the head chips having a minimum value of the estimated heating times so that the head chips reach the target temperature when the maximum estimated heating time elapses.

The foregoing and/or other aspects of the present general inventive concept may also be achieved by providing an apparatus to preheat head chips in a printing device, each head chip including nozzles having main heaters to heat ink to be ejected through the nozzles, a plurality of auxiliary heaters to heat the head chips, and a plurality of temperature sensors measure temperatures of the head chips, the apparatus comprising a controller to receive initial temperatures of the head chips measured by the temperature sensors, to classify the head chips into a high temperature group having the corresponding initial temperatures higher than a target temperature and a low temperature group having the corresponding initial temperatures lower than the target temperature, to calculate estimated cooling times until the head chips of the high temperature group reach the target temperature based on temperature falling rates of the head chips of the high temperature group, to calculate estimated heating times until head chips of the low temperate group reach the target temperature based on temperature rising rates of the head chips of the low temperature group, and to control the auxiliary heaters to operate so that all of the head chips reach the target temperature when a maximum value of the estimated cooling times and the estimated heating times elapses.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating a printing device including a line inkjet head according to an embodiment of the present general inventive concept;

FIG. 2 is a view illustrating a printing device including a shuttle inkjet head according to another embodiment of the present general inventive concept;

FIG. 3 is a cross-sectional view illustrating a head chip included in the printing device of FIG. 1 or FIG. 2 according to an embodiment of the present general inventive concept;

FIG. 4 is a view illustrating an arrangement of auxiliary heaters and temperature sensors on a head chip included in the printing device of FIG. 1 or of FIG. 2;

FIG. 5 is a block diagram illustrating an apparatus to preheat a head chip according to an embodiment of the present general inventive concept;

FIG. 6 is a graph illustrating a method of preheating one or more head chips according to an embodiment of the present general inventive concept;

FIG. 7 is a view illustrating a waveform of a drive signal that drives main heaters of a head chip according to an embodiment of the present general inventive concept;

FIG. 8 is a graph illustrating a method of preheating one or more head chips according to another embodiment of the present general inventive concept;

FIG. 9 is a graph illustrating a method of preheating one or more head chips according to another embodiment of the present general inventive concept;

FIG. 10 is a graph illustrating a method of preheating one or more head chips according to another embodiment of the present general inventive concept; and

FIG. 11 is a graph illustrating a method of preheating one or more head chips according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

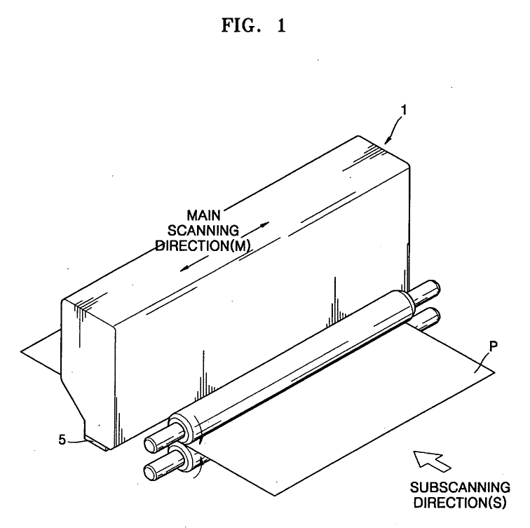

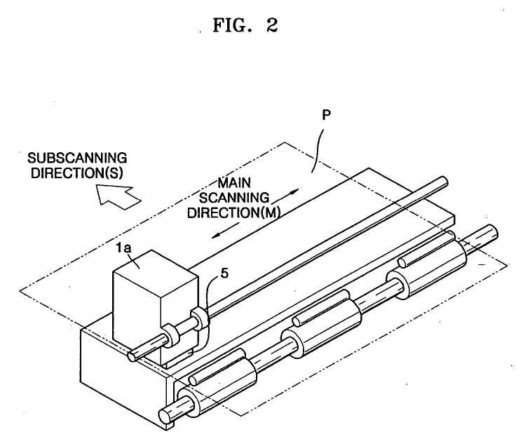

FIGS. 1 and 2 are views illustrating printing devices according to embodiments of the present general inventive concept. Referring to FIG. 1, an inkjet head 1 is installed above a path along which a recording medium, such as a sheet of paper P, is transferred in a sub scanning direction (S). The inkjet head 1 ejects ink to print an image on the recording medium while remaining at a fixed position. Referring to FIG. 2, an inkjet head la reciprocates in a main scanning direction (M), and ejects ink to print an image on a recording medium, such as a paper P, transferred in a sub scanning direction (S). The inkjet head 1a is generally called a shuttle inkjet head and the inkjet head 1 is called a line inkjet head. The shuttle inkjet head 1a of FIG. 2 has one or more head chips that are 0.5-inch long and the line inkjet head 1 of FIG. 1 has head chips 5 that have a length equal to or longer than that of the one or more head chips used in the shuttle inkjet head along the main scanning direction (M).

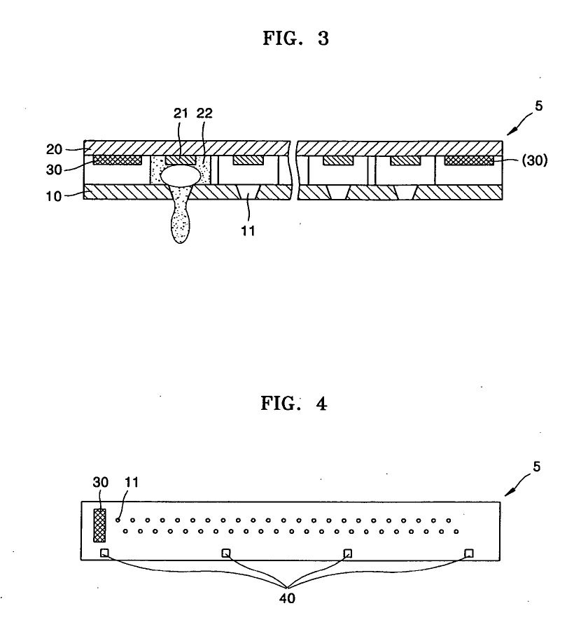

FIG. 3 is a cross-sectional view illustrating a head chip according to an embodiment of the present general inventive concept. The head chip 5 may be used in the line inkjet head 1 or in the shuttle inkjet head 1a. Referring to FIG. 3, the head chip 5 has nozzles 11 through which ink is ejected, and main heaters 21 to heat the ink to be ejected through the nozzles 11. The nozzles 11 are formed on a nozzle plate 10. The main heaters 21 are formed on a substrate 20. A channel is formed between the nozzle plate 10 and the substrate 20 to supply the ink from an ink storage (not shown) to chambers 22. Since a general structure of the head chip 5 is well known to those skilled in the art, detailed description thereof will be omitted. When a voltage is applied to the main heaters 21, the ink contained in the chambers 22 is heated and bubbles are generated therein so that a volume of the ink contained in the ink chambers 22 expands rapidly. The ink within the chambers 22 is ejected through the nozzles 11 due to a pressure caused by the heated ink.

To adjust the viscosity of the ink to a degree appropriate for a printing operation before an image is printed, the head chip 5 is preheated so that a temperature of the head chip 5 reaches a predetermined target temperature. A preheating operation can be performed between printing operations or when power is applied to the printing device (i.e., the printing device is turned on). For the preheating operation, the head chip 5 has one or more auxiliary heaters 30 and one or more temperature sensors 40 installed thereon as illustrated in FIG. 4. For example, the auxiliary heaters 30 may be formed on the substrate 20. Since it is difficult to arrange the auxiliary heaters 30 between the nozzles 11 if there is a limited space in the head chips, the auxiliary heaters 30 may be arranged at one end or at both ends of the head chip 5.

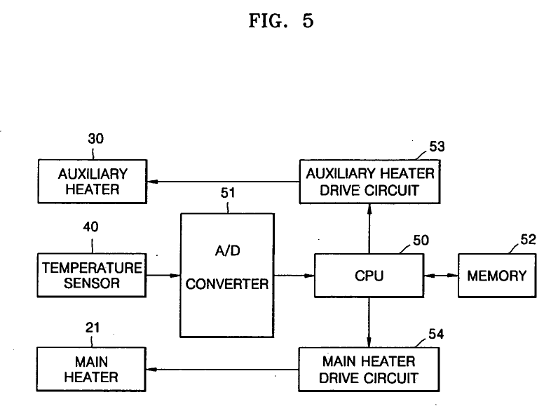

FIG. 5 is a block diagram illustrating an apparatus to preheat a head chip, such as the head chip 5 of FIGS. 3 and 4, thus to control the temperature of the head chip. In other words, the apparatus of FIG. 5 may be used to preheat a head chip similar to the head chips illustrated in FIGS. 3 and 4. Accordingly, for illustration purposes, the apparatus of FIG. 5 is described below with reference to FIGS. 3, 4 and 5. Referring to FIGS. 3, 4, and 5, the temperature of the head chip 5 measured by the temperature sensors 40 may be input to a central processing unit (CPU) 50 through an analog/digital (A/D) converter 51. Information, such as a target temperature, a temperature rising rate and a temperature falling rate of the head chips 5, may be stored in a memory 52. The CPU 50 controls an auxiliary heater drive circuit 53 and a main heater drive circuit 54 to drive the auxiliary heaters 30 and the main heaters 21. Methods of preheating head chips using apparatuses having the above-described structure will be described below. Lower case letters a, b, c and d are used to discriminate between different head chips among the head chips 5, preheated by different respective auxiliary heaters 30, and different respective main heaters 21.

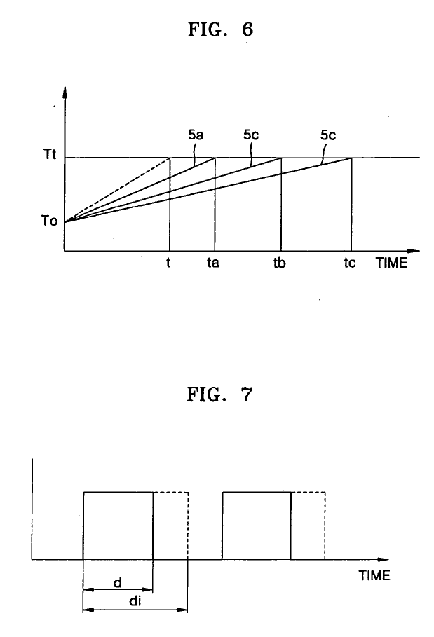

After power is applied to the printing device (i.e., the printing device is turned on) or when a stand-by state of the printing device is maintained for a long time without performing a printing operation, it is expected that initial temperatures of the head chips 5 of the printing device are the same. A method of preheating head chips when the initial temperatures of different head chips of the printing device are the same will be described with reference to FIG. 6. The initial temperatures of head chips 5a, 5b, and 5c are the same as temperature T₀. However, temperature rising rates of the head chips 5a, 5b, and 5c may be different due to a difference in positions of the head chips 5a, 5b, and 5c, or a difference in a resistance of the respective auxiliary heaters 30a, 30b, and 30c. Therefore, although the auxiliary heaters 30a, 30b, and 30c of the head chips 5a, 5b, and 5c are simultaneously driven, preheating times required for the head chips 5a, 5b, and 5c to reach the target temperature Tt are ta, tb, and tc, respectively, which are different. To reduce such differences in the preheating times, ta, tb, and tc, a method of preheating the head chips includes driving main heaters 21a, 21b, and 21c that heat ink to be ejected from the head chips 5a, 5b, and 5c, together with the auxiliary heaters 30a, 30b, and 30c.

When the main heaters 21a, 21b, and 21c are driven, a waveform of a drive signal is controlled so that the ink may not be ejected until all the head chips reach an ejecting target temperature. In other words, referring to FIG. 7, a duty ‘d’ of the drive signal that drives the main heaters 21 is shorter than a duty ‘di’ of the drive signal when the ink is ejected. Therefore, the head chip 5 can be heated by the main heaters 21 while the ink is not ejected. Also, a frequency of the drive signal that drives the main heaters 21a, 21b, and 21c is set to be inversely proportional to the temperature rising rate of the respective head chips 5a, 5b, or 5c. For example, assuming that temperature rising rates of the head chips 5a, 5b, and 5c are d1, d2, and d3, respectively, and drive frequencies of the drive signals of the main heaters 21a, 21b, and 21c of the head chips 5a, 5b, and 5c are f1, f2, and f3, respectively, then the drive frequencies are set so that a relation f1:f2:f3=1/d1:1/d2:1/d3 is satisfied. When the auxiliary heaters 30a, 30b, and 30c are driven together with the main heaters 21a, 21b, and 21c as described above, the target temperature Tt can be reached within a shorter period of time. Also, since the drive frequencies of the drive signals that drive the main heaters 21a, 21b, and 21c are controlled to compensate for differences in the temperature rising rates of the respective head chips 5a, 5b, and 5c, the head chips 5a, 5b, and 5c have almost the same temperature rising rate and can reach the target temperature Tt almost at the same time ‘t’ as illustrated by a dotted line in FIG. 6.

However, even when the time ‘t’ elapses, the temperature of the head chips 5a, 5b, and 5c may not reach the target temperature Tt or may exceed a little the target temperature Tt. Therefore, times of terminating the preheating operations of the head chips 5a, 5b, and 5c may be fine-controlled and adjusted based on measuring the temperatures of the respective head chips 5a, 5b, and 5c using the temperature sensors 40a, 40b, and 40c.

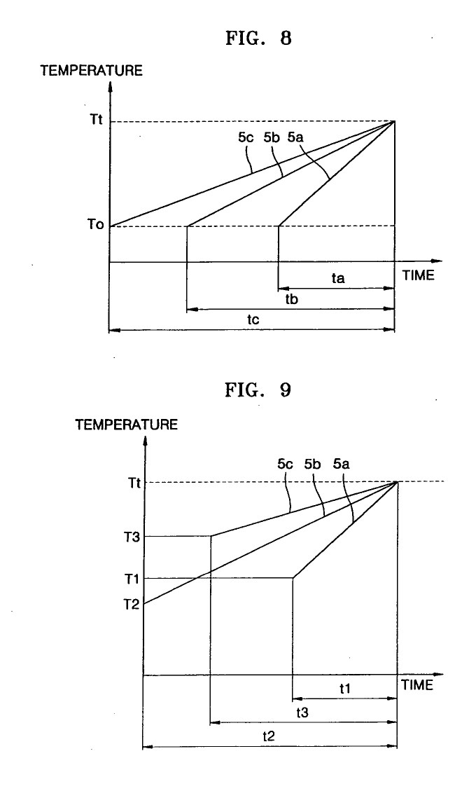

FIG. 8 is a graph illustrating a method of preheating head chips according to another embodiment of the present general inventive concept. The method of heating the head chips 5a, 5b, and 5c to simultaneously reach a target temperature Tt will be descried below with reference to FIG. 8. Estimated heating times required for heating the head chips 5a, 5b, and 5c from the initial temperature T₀ to the target temperature Tt are calculated according to the temperature rising rates of the head chips 5a, 5b, and 5c. For example, referring to FIG. 6, when the head chips 5a, 5b, and 5c start to be heated simultaneously, the estimated heating times until the head chips 5a, 5b, and 5c reach the target temperature Tt from the initial temperature T₀ are ta, tb, and tc (ta<tb<tc). In the method illustrated in FIG. 8, the auxiliary heater 30c of the head chip 5c having a longest estimated heating time is driven first to start heating the head chip 5c. Next, the auxiliary heater 30b of the head chip 5b is driven after a time tc−tb elapses, to start heating the head chip 5b. Last, the auxiliary heater 30a of the head chip 5a is driven after a time tc−ta elapses, to start heating the head chip 5a.

When heating operations of the head chips 5a, 5b, and 5c are started sequentially according to the longest estimated heating time, the head chips 5a, 5b, and 5c reach the target temperature Tt almost simultaneously after the longest estimated heating time tc has elapsed. However, even when the time ‘tc’ elapses, the temperature of the head chips 5a, 5b, and 5c may not reach the target temperature Tt or may exceed a little the target temperature Tt. Therefore, times of terminating heating of the respective head chips 5a, 5b, and 5c may be fine-controlled and adjusted by measuring the temperatures of the respective head chips 5a, 5b, and 5c using the temperature sensors 40a, 40b, and 40c.

When the main heaters 21a, 21b, and 21c are driven together with the auxiliary heaters 30a, 30b, and 30c using a first driving signal having a predetermined duty and frequency, the temperature of the head chips 5a, 5b, and 5c can be raised up to the target temperature Tt more swiftly. Here, the temperature rising rates of the head chips 5a, 5b, and 5c used to calculate estimated heating times when the main heaters 21a, 21b, and 21c are separately driven from the auxiliary heaters 30a, 30b, and 30c may be different from the temperature rising rates when the main heaters 21a, 21b, and 21c are driven together with the auxiliary heaters 30a, 30b, and 30c.

The estimated heating times ta and tb may be recalculated and the heating start times of the head chips 5a and 5b may be adjusted by constantly (or at a predetermined time interval) measuring the temperatures of the head chips 5a and 5b after driving the auxiliary heater 30c of the head chip 5c having the longest estimated heating time to start heating the head chip 5c.

The initial temperatures of the head chips 5a, 5b, and 5c may be different from one other after a printing operation is performed. For example, since the head chips 5a, 5b, and 5c are heated by the main heaters 21a, 21b, and 21c when ink is ejected, the initial temperatures after the printing operation has been performed may be different depending on ink ejection frequencies of the respective head chips 5a, 5b, and 5c. Even when the initial temperatures of the head chips 5a, 5b, and 5c are different from one other, the method of preheating the head chip described in FIG. 8 can be used.

For example, referring to FIG. 9, the initial temperatures of the head chips 5a, 5b, and 5c are T1, T2, and T3, respectively. When the auxiliary heaters 30a, 30b, and 30c of the respective head chips 5a, 5b, and 5c are sequentially driven to start heating the head chips 5a, 5b, and 5c according to the temperature rising rates of the respective head chips 5a, 5b, and 5c, estimated heating times until the head chips 5a, 5b, and 5c reach the target temperature Tt are calculated using the temperature rising rates of the respective head chips 5a, 5b, and 5c. Times taken for the head chips 5a, 5b, and 5c to reach the target temperature Tt are referred to t1, t2, and t3 (t1<t3<t2). The auxiliary heater 30b of the head chip 5b having the longest estimated heating time t2 is driven first to start heating the head chip 5b. Next, the auxiliary heater 30c of the head chip 5c is driven to start heating the head chip 5c after a time t2−t3 elapses. Last, the auxiliary heater 30a of the head chip 5a is driven to start heating the head chip 5a after a time t2−t1 elapses.

When heating is started sequentially from the head chip 5b having the longest estimated heating time t2 even when the initial temperatures of the respective head chips 5a, 5b, and 5c are different, the head chips 5a, 5b, and 5c reach the target temperature Tt almost simultaneously when the longest estimated heating time t2 has elapsed. However, even when the time t2 elapses, the temperatures of the respective head chips 5a, 5b, and 5c may not reach the target temperature Tt or may exceed a little the target temperature Tt. Therefore, times of terminating the heating of the head chips 5a, 5b, and 5c may be fine-controlled and adjusted according to the temperatures of the head chips 5a, 5b, and 5c measured by the temperature sensors 40a, 40b, and 40c.

When the main heaters 21a, 21b, and 21c are driven together with the auxiliary heaters 30a, 30b, and 30c using a second drive signal having a predetermined duty and frequency, the temperatures of the respective head chips 5a, 5b, and 5c can be raised up to the target temperature Tt more swiftly. Here, the temperature rising rates of the head chips 5a, 5b, and 5c driven by the second signal and used to calculate estimated heating times are different from the temperature rising rates when the main heaters 21a, 21b, and 21c are not driven together with the auxiliary heaters 30a, 30b, and 30c using the first drive signal having the predetermined duty and frequency.

The estimated heating times t1 and t3 may be recalculated and heating start times of the head chips 5a and 5c may be adjusted by measuring the temperatures of the head chips 5a and 5c at a predetermined time interval after driving the auxiliary heater 30b of the head chip 5b having the longest estimated heating time t2 to start heating the head chip 5b.

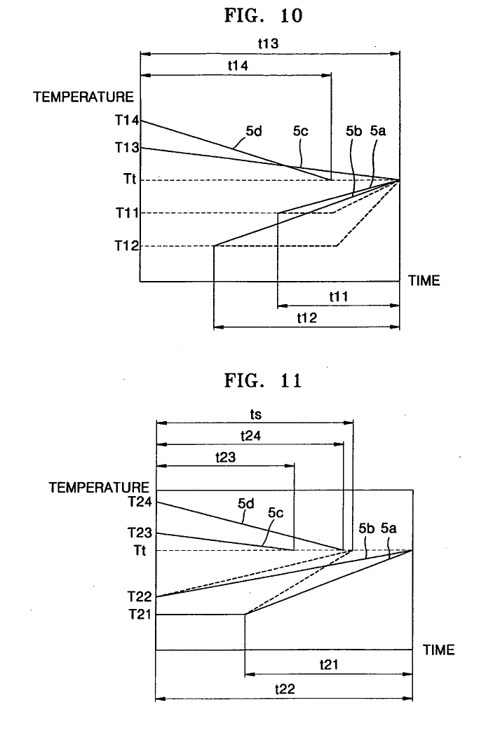

FIG. 10 is a graph illustrating a method of preheating one or more head chips according to another embodiment of the present general inventive concept. Referring to FIG. 10, initial temperatures of the head chips 5a and 5b are T11 and T12, respectively, that are lower than the target temperature Tt, and initial temperatures of the head chips 5c and 5d are T13 and T14, respectively, that are higher than the target temperature Tt. Hence, the head chips 5a and 5b are grouped into a low temperature group and the head chips 5c and 5d are grouped into a high temperature group. Next, estimated cooling times t13 and t14 taken until the head chips 5c and 5d of the high temperature group are cooled down to the target temperature Tt are calculated based on temperature falling rates of the head chips 5c and 5d. Also, estimated heating times t11 and t12 taken until the head chips 5a and 5b of the low temperature group are heated up to the target temperature Tt are calculated based on temperature rising rates of the head chips 5a and 5b.

When a maximum of the estimated cooling time t13 is greater than a maximum value of the estimated heating time t12 as illustrated in FIG. 10, the head chips 5a, 5b, 5c, and 5d may reach the target temperature Tt after the maximum estimated cooling time t13 elapses. For that purpose, the auxiliary heater 30b of the head chip 5b having the longest estimated heating time t12 is driven after a time t13−t12 elapses to start heating the head chip 5b. Next, the auxiliary heater 30a of the head chip 5a is driven after a time t13−t11 elapses, to start heating the head chip 5a. Then, the head chips 5a and 5b reach the target temperature Tt almost simultaneously when the maximum estimated cooling time t13 elapses. However, even when the maximum estimated cooling time t13 elapses, the temperatures of the head chips 5a and 5b of the low temperature group may not reach the target temperature Tt or may exceed a little the target temperature Tt. Therefore, times of terminating the heating of the head chips 5a and 5b may be fine-controlled and adjusted according to the temperatures of the head chips 5a and 5b measured by the temperature sensors 40a and 40b.

When the estimated cooling time t14 elapses, the head chip 5d reaches the target temperature Tt. Until the maximum estimated heating time t13 elapses and after t14, the temperature of the head chip 5d is measured using the temperature sensor 40d and the auxiliary heater 30d is intermittently driven to maintain the head chip 5d at the target temperature Tt.

When the main heaters 21a and 21b are driven together with the auxiliary heaters 30a and 30b using a third signal having a predetermined duty and frequency, the temperatures of the head chips 5a and 5b can be raised up to the target temperature Tt more swiftly. Here, the temperature rising rates used to calculate the estimated heating times may be temperature rising rates when the main heaters 21a and 21b are driven together with the auxiliary heaters 30a and 30b. When the main heaters 21a and 21b are driven together with the auxiliary heaters 30a and 30b, the heating start times of the head chips 5a and 5b of the low temperature group may be delayed a certain time as illustrated by dotted lines in the graph of FIG. 10.

Also, the estimated heating time t11 may be recalculated and a heating start time of the head chip 5a may be adjusted by measuring the temperature of the head chip 5a at a predetermined time interval after driving the auxiliary heater 30b of the head chip 5b having the longest estimated heating time to start heating the head chip 5b.

FIG. 11 is a graph illustrating a method of preheating one or more head chips according to another embodiment of the present general inventive concept. The method described below is a modification of the previous method. Referring to FIG. 11, the initial temperatures of the head chips 5a and 5b are T21 and T22, respectively, that are lower than the target temperature Tt and the initial temperatures of the head chips 5c and 5d are T23 and T24, respectively, that are higher than the target temperature Tt. Here, the head chips 5a and 5b are grouped into a low temperature group and the head chips 5c and 5d are grouped into a high temperature group. Next, the estimated cooling times until the head chips 5c and 5d of the high temperature group are cooled down to the target temperature Tt are calculated based on temperature falling rates of the head chips 5c and 5d. Also, the estimated heating times until the head chips 5a and 5b of the low temperature group are heated up to the target temperature Tt are calculated based on temperature rising rates of the head chips 5a and 5b.

When a maximum value of the estimated heating times t22 is greater than a maximum value of the estimated cooling times t24 as illustrated in the graph of FIG. 11, the head chips 5a, 5b, 5c, and 5d may all reach the target temperature Tt after the maximum estimated heating time t22 elapses. For that purpose, the auxiliary heater 30b of the head chip 5b having the maximum estimated heating time t22 is driven first. Next, the auxiliary heater 30a of the head chip 5a is driven after a time t22−t21 elapses, to start heating the head chip 5a. Then, the head chips 5a and 5b reach the target temperature Tt almost simultaneously when the longest estimated heating time t22 elapses. However, even when the time t22 elapses, the temperatures of the head chips 5a and 5b of the low temperature group may not reach the target temperature Tt or may exceed a little the target temperature Tt. Therefore, times of terminating the heating of the head chips 5a and 5b may be fine-controlled and adjusted by measuring the temperatures of the head chips 5a and 5b using the temperature sensors 40a and 40b.

When times t23 and t24 elapse, respectively, the head chips 5c and 5d reach the target temperature Tt. Until the time t22 elapses after the head chips 5c and 5d have reached the target temperature Tt, the temperatures of the head chips 5c and 5d are measured using the temperature sensors 40c and 40d and the auxiliary heaters 30a and 30b are intermittently driven to maintain the head chips 5c and 5d at the target temperature Tt.

When the main heaters 21a and 21b are driven together with the auxiliary heaters 30a and 30b using a fourth signal having a predetermined duty and frequency, the temperatures of the head chips 5a and 5b can be raised up to the target temperature Tt more swiftly. In this case, the temperature rising rates used to calculate the estimated heating times may be temperature rising rates when the main heaters 21a and 21b are driven together with the auxiliary heaters 30a and 30b. When the main heaters 21a and 21b are driven together with the auxiliary heaters 30a and 30b, it is possible to shorten times until the head chips 5a and 5b of the low temperature group reach the target temperature Tt as much as ‘ts’, so that time differences between times until the head chips 5c and 5d of the high temperature group and the head chips 5a and 5b of the low temperature group reach the target temperature Tt can be reduced.

Also, the estimated heating time t21 may be recalculated and a heating start time of the head chip 5a may be adjusted by constantly (or at a predetermined time interval) measuring the temperature of the head chip 5a after driving the auxiliary heater 30b of the head chip 5b having the longest estimated heating time to start heating the head chip 5b.

In the above-described embodiments, the temperature rising rates and the temperature falling rates of the head chips can be measured in a process of manufacturing a printing device and stored in the memory 52. Also, the temperature rising rates may be calculated by driving the auxiliary heaters of a head chip in a preheating process for a predetermined period of time (or by driving the main heaters with a drive signal having a predetermined duty and frequency together with the auxiliary heaters) and measuring the temperature of the head chip before and after the auxiliary heaters (and the main heaters) are driven. Also, the temperature falling rates may be calculated by driving the auxiliary heaters to raise the temperature of the head chip to a predetermined temperature in a preheating process and leaving the head chip to cool and measuring the temperature of the head chip after a predetermined time elapses. The calculated temperature rising rate and temperature falling rate are stored in the memory 52 and are used to calculate the estimated heating time and estimated cooling time of the head chip.

According to the above-described methods of preheating the head chips of the present general inventive concept, a difference in times until different head chips of a printing device reach the target temperature is reduced, so that the drying of the ink is minimized. Also, the head chip may be preheated to swiftly reach the target temperature. Also, since a preheating start time is controlled based on the initial temperature and the temperature rising rate of the head chip, energy required for the preheating can be reduced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of preheating one or more head chips of a printing device, each head chip including nozzles and main heaters to heat ink to be ejected through the nozzles, one or more auxiliary heaters to heat the head chips, and one or more temperature sensors to measure temperatures of the head chips, the method comprising:
setting a drive signal that drives the main heaters of the head chips so that the ink is not ejected, and setting the drive signal to have a frequency inversely proportional to a temperature rising rate of the respective head chips according to the measured temperatures; and driving the auxiliary heaters and the main heaters to heat the head chips to simultaneously reach a target temperature from the respective temperatures.

2. A method of preheating one or more head chips of a printing device, each head chip including nozzles and one or more main heaters to heat ink to be ejected through the nozzles, one or more auxiliary heaters to heat the respective head chips, and one or more temperature sensors to measure temperatures of the head chips, the method comprising:
measuring initial temperatures of the head chips;
calculating estimated heating times of the head chips until the head chips reach a target temperature based on temperature rising rates of the respective head chips; and
starting heating the head chips by driving the auxiliary heaters from one of the head chips having a maximum value of the estimated heating times to the other one of the head chips having a minimum value of the estimated heating times so that the head chips reach the target temperature when the maximum estimated heating time elapses.

3. The method of claim 2, further comprising:
setting a drive signal that drives the main heaters of the head chips so that ink is not ejected, and simultaneously driving the main heaters and the auxiliary heaters to heat the head chips.

4. The method of claim 3, further comprising:
measuring a temperature of each of the head chips in which a heating operation has not been started to recalculate the estimated heating time thereof; and
adjusting a heating start time according to recalculated heating time.

5. The method of claim 3, wherein when the auxiliary heaters are driven together with the main heaters, the temperature rising rates are determined by a predetermined duty and frequency of the drive signal applied for a predetermined period of time.

6. The method of claim 2, further comprising:
measuring a temperature of each of the head chips in which a heating operation has not been started to recalculate an estimated heating time; and
adjusting a heating start time of the heating operation according to recalculated heating time.

7. A method of preheating head chips in a printing device, each head chip including nozzles and main heaters to heat ink to be ejected through the nozzles, a plurality of auxiliary heaters to heat the head chips, and a plurality of temperature sensors to measure temperatures of the head chips, the method comprising:
measuring initial temperatures of the head chips and classifying the head chips into a high temperature group having the corresponding initial temperatures higher than a target temperature and a low temperature group having the corresponding initial temperatures lower than the target temperature;
calculating estimated cooling times until the head chips of the high temperature group reach the target temperature based on temperature falling rates of the head chips of the high temperature group and calculating estimated heating times until the head chips of the low temperate group reach the target temperature based on temperature rising rates of the head chips of the low temperature group; and
controlling the auxiliary heaters to operate all of the head chips to reach the target temperature when a maximum value of the estimated cooling times and the estimated heating times elapses.

8. The method of claim 7, wherein the controlling of the auxiliary heaters comprises:
driving the auxiliary heaters sequentially starting with auxiliary heaters from one of the head chips having a maximum value of the estimated heating time to another one of the head chips having a minimum value of the estimated time among the head chips of the low temperature group so that all of the head chips of the low temperature group reach the target temperature when the head chip having the maximum estimated cooling time reaches the target temperature, the maximum estimated cooling time being greater than the maximum estimated heating time; and
intermittently driving the auxiliary heaters to maintain the head chips of the high temperature group that have already reached the target temperature at the target temperature until the maximum estimated cooling time elapses.

9. The method of claim 8, further comprising:
measuring a temperature of each of the head chips among the head chips of the low temperature group in which a heating operation has not been started to recalculate an estimated heating time thereof, and adjusting a heating start time of the heating operation of each head chip according to recalculated heating time.

10. The method of claim 8, further comprising:
setting a drive signal that drives the main heaters of the head chips such that ink is not ejected, and simultaneously driving the main heaters when driving the auxiliary heaters to heat the head chips of the low temperature group.

11. The method of claim 10, wherein when the auxiliary heaters are driven together with the main heaters, the temperature rising rates are determined by a predetermined duty and frequency of the drive signal applied for a predetermined period of time.

12. The method of claim 11, further comprising:
measuring a temperature of each of the head chips among the head chips of the high temperature group in which a heating operation has not been started, to recalculate an estimated heating time thereof; and
adjusting a heating start time of the head chip according to the recalculated heating time.

13. The method of claim 7, wherein the controlling of the auxiliary heaters comprises:
starting heating by driving the auxiliary heaters sequentially from one of the head chips having a maximum value of the estimated heating time to the other one of the head chips having a minimum value of the estimated heating time among the head chips of the low temperature group so that all of the head chips of the low temperature group reach the target temperature when the maximum estimated heating time elapses when the maximum estimated heating time is greater than the maximum estimated cooling time; and
intermittently driving the auxiliary heaters to maintain the head chips of the high temperature group that have already reached the target temperature until the maximum estimated heating time elapses.

14. The method of claim 13, further comprising:
measuring a temperature of each of the head chips among the head chips of the high temperature group in which a heating operation has not been started, to recalculate a second estimated heating time thereof; and
adjusting a heating start time according to the recalculated second heating time.

15. The method of claim 13, further comprising:
setting a drive signal that drives the main heaters of each of the head chips so that ink is not ejected; and
simultaneously driving main heaters when continuously driving the auxiliary heaters to heat the head chips of the low temperature group.

16. The method of claim 15, wherein when the auxiliary heaters are driven together with the main heaters, temperature rising rates are determined by a predetermined duty and frequency of the drive signal applied for a predetermined period of time.

17. The method of claim 16, further comprising:
measuring a temperature of each of the head chips among the head chips of the high temperature group in which a heating operation has not been started, to recalculate a second estimated heating time thereof; and
adjusting a heating start time of the heating operation of the head chip according to the recalculated second heating time.

18. A method of preheating head chips of a printing device, the method comprising:
calculating a first time of a first head chip using a corresponding first rate and a second time of a second head chip using a corresponding second rate; and
controlling heaters of the first and second head chips according to the calculated first and second times, such that the first and second head chips to reach a target temperature simultaneously.

19. An apparatus to preheat one or more head chips of a printing device, each head chip including nozzles, main heaters to heat ink to be ejected through the nozzles, one or more auxiliary heaters to heat the respective head chips, and one or more temperature sensors to measure a temperature of the respective head chip, the apparatus comprising:
a main heaters drive circuit to generate a drive signal that drives the main heaters of the respective head chips so that the ink is not ejected, the drive signal having a frequency inversely proportional to a temperature rising rate of the respective head chips; and
an auxiliary heaters drive circuit to drive the auxiliary heaters and the main heaters of the head chips to heat the head chips to simultaneously reach a target temperature.

20. An apparatus to preheat one or more head chips of a printing device, each head chip including nozzles, one or more main heaters to heat ink to be ejected through the nozzles, one or more auxiliary heaters to heat the respective head chips, and one or more temperature sensors to measure temperatures of the respective head chips, the apparatus comprising:
a controller to receive initial temperatures of the head chips measured by the temperature sensors, to calculate estimated heating times of the head chips until the head chips reach a target temperature based on temperature rising rates of the respective head chips, and to control heating the head chips by driving the auxiliary heaters corresponding to the head chips sequentially from one of the head chips having a maximum value of the estimated heating times to the other one of the head chips having a minimum value of the estimated heating times so that the head chips reach the target temperature when the maximum estimated heating time elapses.

21. An apparatus to preheat head chips in a printing device, each head chip including nozzles having main heaters to heat ink to be ejected through the nozzles, a plurality of auxiliary heaters to heat the head chips, and a plurality of temperature sensors measure temperatures of the head chips, the apparatus comprising:
a controller to receive initial temperatures of the head chips measured by the temperature sensors, to classify the head chips into a high temperature group having the corresponding initial temperatures higher than a target temperature and a low temperature group having the corresponding initial temperatures lower than the target temperature, to calculate estimated cooling times until the head chips of the high temperature group reach the target temperature based on temperature falling rates of the head chips of the high temperature group, to calculate estimated heating times until head chips of the low temperate group reach the target temperature based on temperature rising rates of the head chips of the low temperature group, and to control the auxiliary heaters to operate so that all of the head chips reach the target temperature when a maximum value of the estimated cooling times and the estimated heating times elapses.

22. An apparatus to preheat head chips of a printing device, the apparatus comprising:
a controller to calculate a first time of a first head chip using a corresponding first rate and a second time of a second head chip using a corresponding second rate, and to control heaters of the first and second head chips according to the calculated first and second times, so that the first and second head chips to reach a target temperature simultaneously.
